(19) United States
(12) Patent Application Publication
(10) Pub. No.: US 2013/0078339 A1
(43) Pub. Date: Mar. 28, 2013

(54) High Pressure Processing of Pathogenostat-Treated Food Articles

(71) Applicants: Caitlin Elizabeth Trahan, Oakland, CA (US); Justin Wade Shimek, San Ramon, CA (US); Kirin Basra, Fairfield, CA (US); Kirsten O'Brien, Walnut Creek, CA (US); Karim Nafisi-Movaghar, Walnut Creek, CA (US)

(72) Inventors: Caitlin Elizabeth Trahan, Oakland, CA (US); Justin Wade Shimek, San Ramon, CA (US); Kirin Basra, Fairfield, CA (US); Kirsten O'Brien, Walnut Creek, CA (US); Karim Nafisi-Movaghar, Walnut Creek, CA (US)

(21) Appl. No.: 13/245,975

(22) Filed: Sep. 27, 2011

(51) Int. Cl. A23L 3/3454; B65D 85/00; A23L 3/015

(52) U.S. Cl. 426/107; 426/323; 426/106

(57) ABSTRACT

The disclosure relates to method of treating foodstuffs such as whole or cut vegetables or fruits or cuts of meat in a manner that reduces the load of human or other animal pathogens in the foodstuff, preferably without substantially altering its appearance, one or more of its organoleptic properties, or some combination of these. The method includes contacting the foodstuff with a pathogenostatic fluid such as an acidic solution, preferably at a reduced pressure, and thereafter subjecting the foodstuff to an HPP process. Foodstuffs treated in this manner can be packaged in the presence of the pathogenostatic fluid, in the presence of a sauce, or in the presence of substantially no liquid. Packaged foodstuffs treated as described herein exhibit beneficial properties, such as retention of taste, appearance, and texture and extended shelf life, relative to non-treated foodstuffs.

### FIELD OF THE DISCLOSURE

The disclosure relates generally to the field of high pressure processing of food articles, including vegetables, for the purpose of mitigating or eliminating the risk of microbial growth in or on an article.

### BACKGROUND OF THE DISCLOSURE

High pressure processing (HPP), also known as high hydrostatic pressure processing, pascalization, and bridgmanization, is a technique whereby articles such as food items are subjected to pressure of an intensity and for a duration of time sufficient to reduce the biological activities of cells and their components, thereby decreasing the likelihood that cells subjected to such processing will continue to metabolize or reproduce. As such, HPP techniques can be used to mitigate or eliminate the risk that bacteria, mold, yeast, and parasites will survive or multiply in or on HPP-treated articles. HPP techniques can also be used to reduce the respiration rate of cells in living or previously-living foodstuffs, such as meats and vegetables.

Foodstuffs intended for human or other animal consumption are susceptible to microbial contamination, especially during handling and processing, and such contamination can continue and increase during storage. Furthermore, natural components (e.g., endogenous enzymes) in foodstuffs such as vegetables, fruits, and meats can exert degradative effects upon the foodstuff during storage, even in the absence of microbial contamination. A continuing need exists for methods of reducing spoilage and degradation of foodstuffs during storage. HPP methods have been widely investigated and reported. Their efficacy for reducing the risk of contamination of foodstuffs and thereby extending the period for which foodstuffs can practically be stored has been demonstrated by others.

In HPP techniques, food or other articles are often sealed in a container prior to subjecting the sealed container to high pressure, such as 200-1000 megaPascals (MPa; more typically 200-600 MPa). Because gases are highly compressible at such pressures, some or substantially all gases can be removed from the container prior to sealing it, such as by evacuating gases from the container or by filling the container with liquid prior to sealing it. Liquids and solids, being relative incompressible at these pressures, tend to transmit pressure throughout their volume, provided there are no rigid articles present (e.g., thick, hollow bones or shells capable of preventing transmission of isotropically applied pressure to their interior). Pressure can be applied to the exterior of the article or the exterior of the container containing the article and transmitted throughout the article. In practice, pressurization is often achieved in a sturdy device designed for accommodating one or more articles during such pressurization. Pressurization devices often have controls for selecting the pressure and the duration of pressurization and indicators for indicating the pressure achieved and/or the duration of the pressurization process.

Following HPP treatment, non-compressible articles such as liquid foods (e.g., soups and juices) often appear similar to or indistinguishable from non-treated articles of the same type. Furthermore, many HPP-treated foodstuffs retain their original texture and flavors (or texture and flavors very similar to their original ones) following HPP treatment. Particularly for packaged vegetables and other foodstuffs having a characteristic solid or semi-solid texture or mouthfeel, retention of the texture or mouthfeel is considered important to many consumers. These characteristics are often degraded, however, by food processing treatments intended to improve food safety and facilitate storage and shipping.

A drawback of HPP processing is that the high pressure treatment alone does not necessarily inactivate at least some spores and cysts that can be present in foodstuffs. Some human pathogens are known to exhibit significant resistance to HPP processing alone (e.g., spores of certain molds, fungi, and bacteria such as Clostridium species, including C. botulinum and C. perfringens, and Bacillus species, including B. cereus, and cysts of organisms such as those of the genera Cryptosporidium, Cyclospora, and Toxoplasma). Spores of C. botulinum are a well-recognized danger in the field of food processing, in that they are known to survive and proliferate under anaerobic or microaerophilic storage conditions, even in HPP-treated foods. Unfortunately, many of those spores and cysts occur naturally on or in close association with (e.g., in soil) foodstuffs or their ingredients. The presence of those potential pathogens in such foodstuffs necessitates processing to reduce the likelihood that the potential pathogens will cause mortality or morbidity in consumers. The need for appropriate processing of such foodstuffs is well known.

Most pathogenic spores and cysts (as well as other pathogens) can be removed from foodstuffs by one or more of washing, heating, and pressurization. For pressure-insensitive pathogens, washing is seldom sufficient to reliably remove the pathogen to insignificant levels unless the foodstuff is either heated or washed with relatively chemically-reactive washing reagents. Either of these treatments will adversely affect the appearance, taste, texture, mouthfeel, or other organoleptic properties, or both, of many foodstuffs, and have limited desirability for that reason. By way of example, cooking raw vegetables appropriately will inactivate most spore or cysts, but appropriate cooking processes tend to significantly alter the texture (e.g., the crispness), especially if the cooked vegetables are stored for substantial periods of time prior to consumption. Chemical or radiological treatment (e.g., irradiation, ozone treatment or packaging in oxygen) can alter the appearance and organoleptic properties of foodstuffs as well, and foods treated using many of these processes are furthermore considered undesirable by consumers on the basis of the treatment alone.

Packaging of foods in brines or acidic solutions is known to inhibit growth of human pathogens in the packaged food. Such packaging is also known to inhibit cellular respiration that might consume oxygen within a packaged foodstuff, leading to anaerobic or microaerophilic conditions amenable to pathogen survival and growth. However, brines and acids can impart undesirable tastes and textures to packaged foodstuffs and can also present an undesirable appearance of the packaged foodstuff

A substantial need exists for methods of processing foods that potentially contain HPP-resistant pathogens and that are intended for human consumption (or for consumption by other animals, such as pets, companion animals, and farm animals). Such methods should preferably by applicable to a broad range of foodstuffs, especially vegetable foodstuffs (i.e., those which are, or are derived from, plants and parts thereof) and should preferably enable storage for extended periods of time (e.g., days, weeks, or months) without significantly altering, at least in undesirable ways, the pre-processing appearance and/or organoleptic properties of the treated foodstuff.

Others have recognized the need for such processing techniques and have proposed solutions.

By way of example, U.S. patent application Ser. No. 11/397,900 of Love et al. discloses HPP processing of crab cakes packaged in oxygen-permeable materials. HPP processing of the crab cakes inactivates many pathogens, but potentially leaves HPP-insensitive spores (e.g., C. difficile spores) viable; packaging the crab cakes in oxygen-permeable film permits oxygen to infuse into the packaged product, inhibiting or preventing germination of the spores, and growth or proliferation of the organisms germinated therefrom. Even if Love's process efficaciously inhibits pathogen survival or growth, many packaged foodstuffs would be degraded (e.g., oxidized) upon prolonged contact with oxygen, and this method would not be a suitable process for packaging of oxygen-sensitive foodstuffs intended for prolonged storage over a period of days, weeks, months, or years.

Adams et al., in U.S. Pat. No. 5,151,286, disclose soaking vegetables in a concentrated acidic brine and then packaging the treated vegetables in a light-impermeable container. Adams proposes that the brine/acid treatment reduces cellular respiration in the vegetable matter, and that preventing light contact with the treated vegetable reduces formation of chemical products having undesirable tastes. Evidently, the brine/acid soaking is the only treatment intended to reduce pathogen load in the vegetables so treated, although control of the gas content of the package (which could also inhibit pathogen growth) is also disclosed.

U.S. Pat. No. 5,000,972 to Nafisi-Movaghar et al. discloses that a solution containing certain sugars and an anti-microbial agents can be infused into fruit pieces (e.g., by soaking or by vacuum infusion) and that the treated fruit pieces can be dried and stored for extended periods, presumably without substantial risk of pathogen proliferation in the stored dried fruit. Similarly, Basker et al. disclose in U.S. Patent Application Publication Number 2009/0297671 that fruits and vegetables can be infused with a soluble-fiber-containing solution and thereafter vacuum fried to yield a low moisture fruit or vegetable product that exhibits significant shelf life. U.S. Patent Application Publication No. 2009/0047400 (Basker et al.) discloses a process and apparatus for “hybrid” infusion of food pieces, wherein the food pieces are contacted with a solution to be infused into the pieces, both at atmospheric pressure and at reduced pressure. The application discloses that the solution can include sugars (e.g., corn syrup solids), which are known to inhibit bacterial proliferation at high concentrations, and that pieces so treated can be subjected to further processing, such as vacuum frying. However, each of the processes in these three patent documents substantially alters the appearance and organoleptic properties of the fruit/vegetables that are subjected to the processes.

Disclosed herein are methods of treating foodstuffs, including vegetable foodstuffs, so as to reduce both their load of vegetative animal pathogens and HPP-resistant pathogens (e.g., non-vegetative spores and cysts) and, optionally, also retain much of the appearance and organoleptic properties of the foodstuffs prior to such treatment. The methods disclosed herein facilitate long-term storage of treated foodstuffs.

### BRIEF SUMMARY OF THE SEVERAL VIEWS OF THE DRAWINGS

FIG. 1 is a simple flow chart that illustrates one method described herein, wherein a foodstuff is contacted with a pathogenostatic fluid prior to subjecting the foodstuff to an HPP technique.

FIG. 2 is a flow chart that illustrates an example of preparing a packaged vegetable mix having a dressing using the methods described herein.

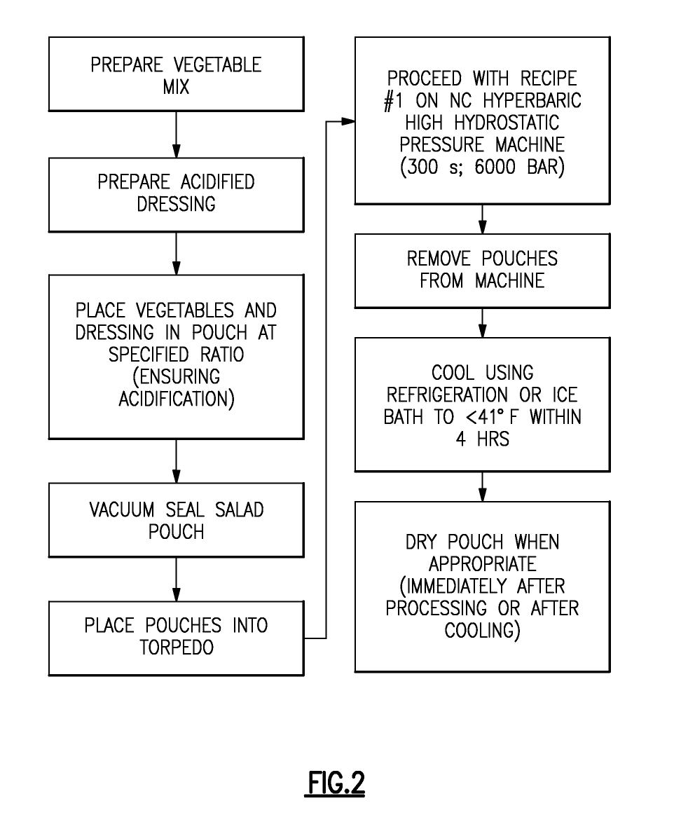

FIG. 3 is a flow chart that illustrates an example of preparing packaged vegetables having a brine infused therein, but no free brine within the package, using the methods described herein.

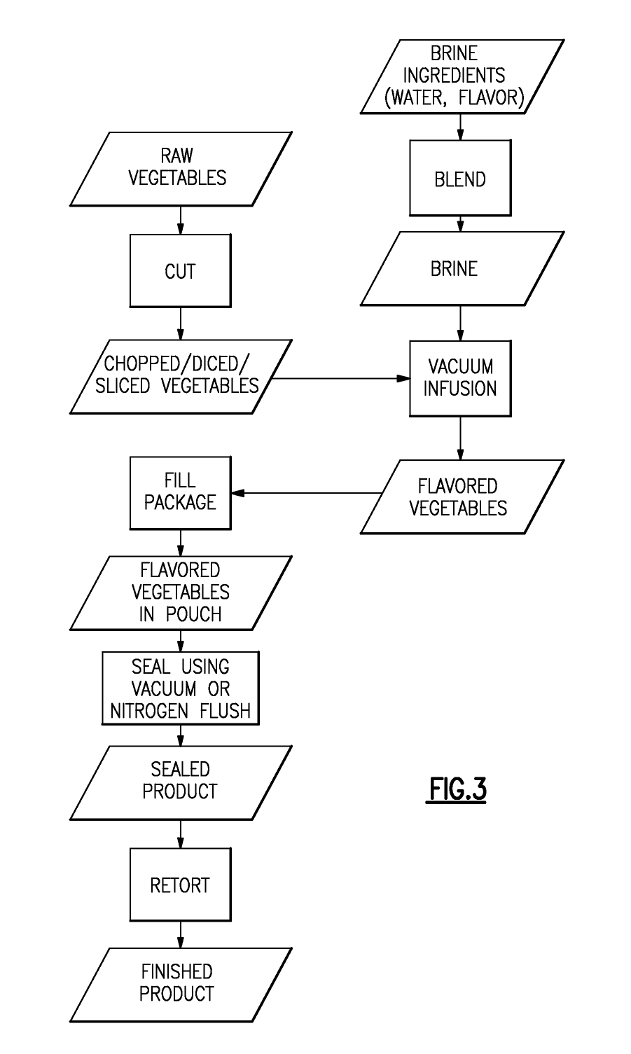

FIG. 4 is a flow chart that illustrates an example of preparing packaged vegetables having a sauce infused therein, with additional non-infused sauce within the package, using the methods described herein.

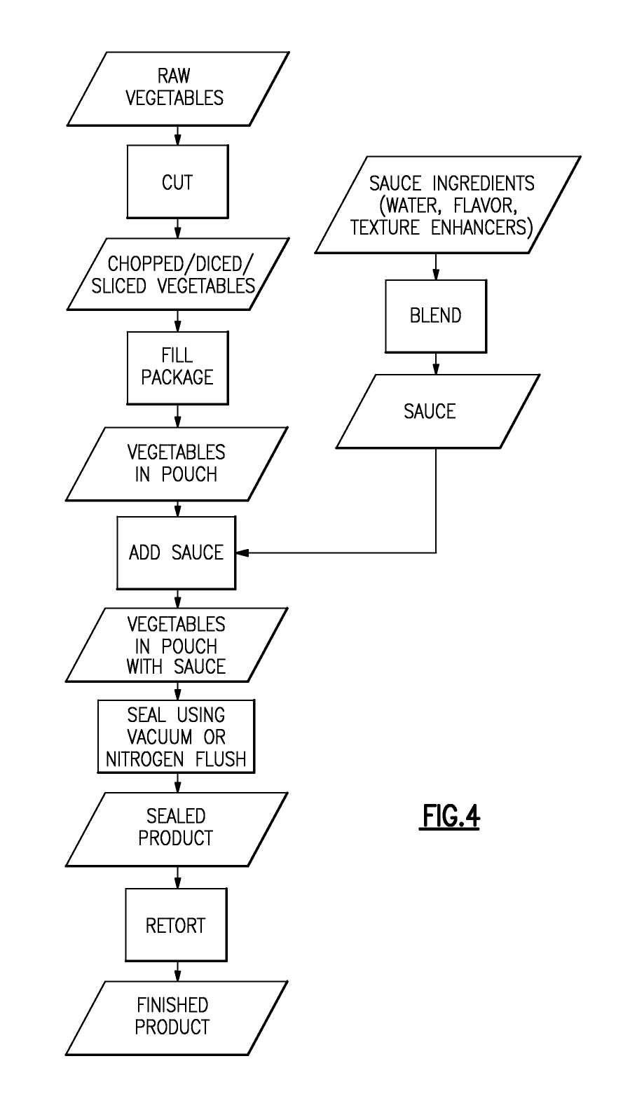

### DETAILED DESCRIPTION

The disclosure relates to methods of food processing that enhance the microbiological safety of the processed foodstuff

HPP food-processing methods are well known and described by others. Although HPP methods are known to be effective for enhancing the microbial safety of treated food products. It is believed that the high pressures (e.g., about 20-120 kpsi) exerted upon HPP-treated foods renders vegetative pathogenic microorganisms harmless. However, HPP methods have the significant drawback that HPP treatment often fails to render harmless certain pressure-resistant pathogens, such as microbiological spores and cysts, that are found in some foodstuffs.

Pressure-resistant pathogens can occur in soil, plants, animals, and food processing equipment and workers and be transmitted from these or other sources into or onto foodstuffs. Failure to eliminate or inactivate pressure-resistant pathogens can lead to serious human or veterinary illnesses upon ingestion of the pathogens. For that reason, foodstuffs which can reasonably be anticipated to potentially harbor pressure-resistant pathogens are typically not treated using HPP processes alone. Pressure-resistant pathogens can be eliminated or inactivated by treating such foodstuffs by other methods (e.g., by heating or freezing them) or by maintaining HPP-treated foodstuffs under conditions (e.g., refrigeration or at a controlled pH) that inhibit or prevent pressure-resistant pathogens from germinating in HPP-treated foodstuffs. However, each of these additional steps can significantly increase the effort and cost of rendering or maintaining the foodstuff in a state in which it can be safely eaten by a human or animal. Furthermore, heating or freezing certain foodstuffs (e.g., some fruits and vegetables) can result in undesirable organoleptic changes (avoidance of such changes is a common motivation for using HPP techniques). Food processing methods capable of reducing or eliminating the health threat attributable to pressure-resistant pathogens in HPP-treated foodstuffs could avoid the effort, expense, and organoleptic changes associated with methods previously used by others to address such pathogens. This disclosure provides such food processing methods.

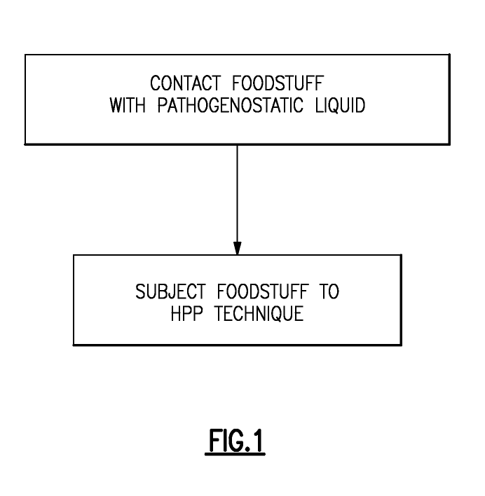

Simply summarized, and as shown in FIG. 1, the methods involve two processes. In a first process, a foodstuff is contacted with a pathogenostatic fluid (e.g., a gas such as sulfur dioxide or a liquid such as an acidic solution or a brine). Distribution of the pathogenostatic fluid or of one or more components thereof throughout the foodstuff inhibits germination of pressure-resistant pathogens in the foodstuff after it has been subjected to the methods. However, the pathogenostatic fluid does not necessarily affect any vegetative microorganism. In a second process, which is an HPP treatment of the types widely known in this field, super-atmospheric pressure applied to the foodstuff reduces the fraction of the vegetative microorganisms in the foodstuff that remain vegetative after it is subjected to the HPP treatment. Preferably, most or all vegetative microorganisms (or at least most or all vegetative pathogenic microorganisms) in the foodstuff are rendered non-vegetative by the HPP treatment. The two processes can be performed sequentially in either order or they can be performed simultaneously (e.g., by using the pathogenostatic fluid as the working fluid within the pressure vessel of the HPP treatment process).

In a preferred embodiment, the foodstuff is contacted with the pathogenostatic fluid and sealed within an HPP-compatible package prior to subjecting the package to the HPP process. Thus, by way of example, whole, sliced, or mashed vegetables can be contacted with an acidic solution in a vacuum vessel (typical pressure<0.1 atmosphere), such that the acidic solution is taken up into voids within the vegetables and yield vegetables having a low pH (e.g., pH<4.6) throughout. The acidified vegetables can be vacuum sealed in a flexible plastic pouch (e.g., a polyethylene pouch, or one made of laminated plastic having a substantially oxygen-impermeable layer, such as an ethyl vinyl alcohol copolymer layer; “oxygen-impermeable” here means a film which facilitates diffusion of oxygen therethrough at a sufficiently low rate when maintained in an air atmosphere that foodstuffs can be stored within the film for a practical period, such as 10 days or more). The pouch can be subjected to an HPP technique, such as one that exerts pressure upon and throughout the pouch of 20-120 kpsi (preferably 35-87 kpsi, such as for 1-30 minutes, in either a single pressurization step or a series of alternating or pulsatile pressurization/depressurization cycles). The HPP technique can be expected to render innocuous any vegetative microorganisms that may be present within the pouch, including any vegetative pathogens, but it can be anticipated that pressure-resistant pathogens (e.g., C. botulinum spores) that may be present within the package will remain viable (i.e., capable of assuming a vegetative state). However, because C. botulinum spores cannot germinate at acidic pH values (<4.6), the packaged, acidified, HPP-treated vegetables can be expected to remain free of vegetative pathogens, at least so long as the package remains sealed, because the acidic environment will prevent generation of vegetative C botulinum organisms from spores and the sealed packaging will prevent influx of vegetative organisms into the package.

Advantageously, the methods described herein can be used to prepare packaged foodstuffs that can be safely eaten by humans or animals with reduced or no danger of food poisoning caused by pathogens borne by the packaged foodstuffs. Furthermore, so long as refrigeration or freezing of the packaged foodstuff is not required or desired to prevent non-microbial degradation of the foodstuff, the methods described herein can be used to make packaged foodstuffs that can be stored without such refrigeration and storage. Thus, fruits, vegetables, and other foodstuffs treated as described herein can be stored under refrigerated conditions (e.g., at a temperature of about 4 degrees Celsius) for days, weeks, months, or years without significant concern for pathogenic contamination, and in some instances without the need for refrigeration.

Definitions

As used herein, each of the following terms has the meaning associated with it in this section.

A “foodstuff” is an item or article that is edible (including drinkable) by an animal such as a human or is useful as an ingredient for making an edible item or article. Non-limiting examples of foodstuffs include fruits, vegetables, juices, grains, flours, pastas, animal milks, yogurts, cheeses, sweetened beverages, cuts of meat, and processed foods.

A “pathogen” is a microorganism capable of causing a human or veterinary disease (e.g., “food poisoning”) when ingested by a human or animal. Some pathogens can exist in multiple forms, including in a vegetative form and a pressure-resistant form. A “vegetative” microorganism is one which is actively metabolizing (e.g., producing pathogenic toxins), growing in size, or reproducing (e.g., by division or budding). A “pressure-resistant” form of a microorganism is a form which is capable of attaining a vegetative form after it has been subjected to hydrostatic pressure characteristic of HPP methods (e.g., 20-120 kpsi). Spores and cysts of pathogenic microorganisms are common forms of pressure-resistant pathogens, but it is recognized that such pressure-resistant forms remain relatively poorly characterized and the terms “spore” and “cyst” are loosely used by workers in this field.

A “pathogenostat” is a compound or composition of matter that inhibits or prevents one or more of i) growth of a pathogen; ii) replication of a pathogen; iii) metabolism in a pathogen; iv) germination of a pressure-resistant form of a pathogen such as a spore or cyst v) conversion of a pressure-resistant form of a pathogen to a vegetative form of the pathogen; and vi) survival of a pathogen, including a pressure-resistant form or a vegetative form thereof. A wide variety of pathogenostats are known in the art, including those effective against pressure-resistant forms (see, e.g., Russell, 1990, Clin. Microbiol. Rev. 3(2):99-119). It is also understood in the art that the amount or concentration of a pathogenostat necessary to exert such activity varies in predictable ways with the identity of the pathogen, the characteristics of the ambient environment of the pathogen, and other factors within the ken of the skilled artisan in this field.

“Water activity” is the vapor pressure of a liquid (e.g., the pathogenostatic liquid described herein, either alone or in combination with all other liquid content of a foodstuff) divided by the vapor pressure of pure water at the same temperature. Water activity generally accounts for the tenacity with which water associates with various non-aqueous constituents and solids in a system. It is well known that various microorganisms and pathogens cannot survive, metabolize, reproduce, or germinate in environments in which the water activity is less than a value characteristic of the microorganism or pathogen. By way of example, water activity values less that 0.5 are incompatible with any of survival, metabolism, reproduction, or germination of substantially all known microorganisms and pathogens, and very few (other than a few fungi) can exhibit these phenomena at water activity values less than 0.7. C. botulinum, for example, is believed to exhibit none of these activities at water activity values less than about 0.97, regardless of whether it is present as a vegetative cell or a spore, and corresponding values are 0.95 for C. perfringens and 0.93 for B. cereus.

A “hydrophile” is a composition or compound with which water molecules associate strongly when the hydrophile is combined with water. Hydrophiles include humectants and hygroscopics, which are compounds which associate so tenaciously with water molecules that atmospheric humidity tends to condense on the compounds. Significantly, adding a hydrophile to water or to an aqueous solution tends to decrease the water activity of the solution, because a fraction of water molecules in the solution tend to associate strongly with the hydrophile and are less available for interaction with other compounds or surfaces that the solution contacts. Numerous hydrophiles and their hydrophilic properties are know, including table salt (sodium chloride) and other salts, gums (e.g., xanthan gum), engineered polymers (e.g., polyethylene glycols), and many other compounds.

An article or ingredient is “comestible” if it is suitable for eating as a food or as a component of a food. Comestible articles will generally not have a taste, texture, aroma, or mouthfeel that would render an otherwise edible, appetizing food unappetizing or inedible when combined with the food.

“Organoleptic” properties of foods and foodstuffs refer to the properties that can be detected using the sense organs of an animal, such as color, taste, scent, texture, consistency, and combinations of these, such as the combination of sensations referred to in this field as “mouthfeel.”

An “HPP-compatible” package is a package which is capable of isolating a packaged item (e.g., a foodstuff, with or without additional fluid such as a sauce or brine) from the environment surrounding the package, and which is capable of maintaining that isolation upon subjecting the package and its contents to an HPP technique, such as pressurization to 20-87 kpsi.

The unit “kpsi” is used in its art-accepted sense, i.e., thousands of pounds per square inch of (gauge) pressure.

Detailed Description

This disclosure relates to methods of reducing the risk that the consumer of a foodstuff will develop food poisoning attributable to a pathogenic microorganism borne by the foodstuff. The microbiological safety of the foodstuff is thereby enhanced. The methods involve subjecting the foodstuff to an HPP technique and contacting the foodstuff with a pathogenostatic fluid, such as a liquid having a pathogenostat dissolved therein. The HPP technique inhibits vegetative pathogens present in the foodstuff and the pathogenostatic fluid (or at least the pathogenostat therein) is infused throughout the foodstuff and inhibits pressure-resistant forms of pathogens (which the HPP technique may fail to inhibit) that may be present in the foodstuff.

The Pathogenostatic Fluid

Substantially any fluid (i.e., liquid or gas) that is or includes a pathogenostat can be used as the pathogenostatic fluid in the methods described herein. The role of the pathogenostatic fluid in the methods is to achieve occurrence of one or more pathogenostats throughout the foodstuff at level(s) that are sufficient to inhibit germination of the pressure-resistant forms of a pathogen that may be present in the foodstuff. Whether the pathogenostat has any effect on non-pressure-resistant forms of the pathogen(s) is immaterial, as such forms will be inhibited by the HPP technique to which the foodstuff is subjected.

In one embodiment, the process of contacting the foodstuff with the pathogenostatic fluid is, by itself (i.e., regardless of whether the HPP technique is performed) sufficient to achieve pathogenostat levels that inhibit pressure-resistant forms of at least one (and preferably all) pathogens present in the foodstuff, throughout the foodstuff (or, at least, throughout all portions of the foodstuff at which occurrence of such forms can reasonably be expected and which can be reasonably expected to be eaten by a consumer).

In another embodiment contacting the foodstuff with the pathogenostatic fluid, by itself, does not achieve sufficient pathogenostat levels throughout the foodstuff, but those levels are achieved when the HPP technique is thereafter performed. Thus, for example, it is sufficient if contacting the foodstuff with the pathogenostatic fluid results in a high surface layer concentration of the pathogenostat, but a relatively low concentration (or substantially none of the pathogenostat) in the interior of the foodstuff, so long as the pathogenostat diffuses, convects, or is forced into the interior portion (or at least into whichever parts pathogens may occur) by the time the HPP technique is completed, or relatively soon thereafter (i.e., such that the sufficient pressure-resistant-form-inhibitory level of the pathogenostat is achieved internally by the time germination, growth, or conversion to a vegetative form occurs.

Numerous methods of contacting a foodstuff with a fluid are known, and substantially any can be used to contact the foodstuff with the pathogenostatic fluid. By way of example, the foodstuff can be rinsed, soaked, immersed, intermittently sprayed, or depressurized-and-repressurized (e.g., undergo vacuum infusion) in the presence of the fluid, whether the fluid be gaseous or liquid. Preferably, the pathogenostatic fluid is a liquid that is or contains a pathogenostat, such as an aqueous solution of an comestible acid, such as acetic acid, a table or sea salt solution, or a combination of these. By way of example, a relatively porous foodstuff (e.g., cooked rice or boiled potatoes) can simply be soaked in such a fluid, so that the pathogenostat (in this instance, effective hydrogen cation concentration, as indicated by pH, and sodium cation/chloride anion concentrations) diffuses throughout the foodstuff.

In a preferred method of infusing the pathogenostatic fluid into a foodstuff, the fluid and the foodstuff are contacted at a reduced pressure, such as at a sub-atmospheric pressure. Preferably, the foodstuff and the fluid are contacted prior to reducing the pressure. Upon pressure reduction, air (or another gas) in voids within the foodstuff expand and tend to be released from the foodstuff. Either immediately or upon decreasing the pressure, fluid on the surface of the foodstuff, in a surface layer of the foodstuff, or in which the foodstuff is immersed can replace the escaping gas, resulting in infusion of the fluid into the foodstuff. Regardless of the mechanism by which this infusion occurs, such methods (e.g., vacuum infusion) are well known in the art to result in incorporation of liquid into foodstuffs such as fruits and vegetables.

The pathogenostatic fluid can contain one or more ingredients other than the pathogenostat. The fluid can include solvents such as water, honey, or other (preferably comestible) solvents. The pathogenostatic fluid can also include flavors, humectants, sweeteners, colorants, vitamins, minerals, or substantially any other ingredient known for incorporation into food. In fact, for foodstuffs lacking a desired flavor or property, the pathogenostatic fluid with which the foodstuff is contacted can be a convenient way of delivering a composition that imparts the flavor or property to the foodstuff

In one preferred embodiment, the pathogenostatic fluid takes the form of a sauce intended for consumption with the foodstuff, such as a cheese-containing or—flavored sauce that is consumed together with (i.e., as an accompaniment to, whether or not the sauce is infused within) a vegetable. In this embodiment, the sauce can be formulated to include a pathogenostat and can be both infused into the foodstuff and present within a package containing the foodstuff in a controlled or non-controlled excess amount. By way of example, the foodstuff can be packaged to include an amount of sauce that is proportional to the weight of the foodstuff or to the volume of the foodstuff. Alternatively, the foodstuff can be packaged so that the package contains no excess sauce beyond the amount infused into the foodstuff

In another embodiment, the foodstuff is contacted with a pathogenostatic fluid to achieve adequate pathogenostat levels on and within the foodstuff and is packaged with a different fluid (e.g., a sauce or cooking fluid). The different fluid may contain the same pathogenostat, one or more different pathogenostats, or no pathogenostat. When pathogenostat-infused foodstuffs are contacted with a fluid other than the pathogenostatic fluid, care should be taken to ensure that pathogenostat levels within the foodstuff are maintained at levels adequate to inhibit pressure-resistant pathogens that may be present in the foodstuff throughout the expected period of contact between the foodstuff and the other fluid. By way of example, it is known that some foodstuffs (e.g., certain fruit and vegetable pieces) will exude liquid (“weep”) upon storage, cooking, or both. Pathogenostat levels should be selected to account for any such weeping that can be anticipated. The necessary calculations and considerations to achieve this are within the ken of a skilled artisan in this field.

It is not critical which pathogenostat(s) are used in the methods described herein. The identity and amount of the pathogenostat, as well as its method of infusion into or contact with the foodstuff should be selected such that, after such infusion or contact, conditions throughout the foodstuff are pathogenostatic. In the case of pathogenostats that exert their action directly upon pathogens and their pressure-resistant forms, the pathogenostat will generally be disposed throughout (at least the edible portions of) the foodstuff at a sufficient level to exert the desired pathogenostatic effect. Because separation of such pathogenostats from the foodstuff prior to consumption of the foodstuff will generally be impractical, such pathogenostats should be selected to be comestible, and preferably not to impart any undesirable taste, odor, appearance, texture, or other organoleptic property to the foodstuff when present at an effective pathogenostatic level. Pathogenostats that exert their pathogenostatic effect throughout a foodstuff without necessarily being present throughout the foodstuff (e.g., water activity-lowering compositions) need not be comestible so long as they can be separated from the foodstuff prior to its consumption.

Examples of suitable pathogenostats include hydronium ions (i.e., acidity, as measured by pH, for example), various known salts (e.g., table salt, nitrates, phosphates, and sulfites), and comestible chemical agents known to inhibit spores and cysts of pathogens. Such pathogenostats can be incorporated into pathogenostatic fluids formulated as brines, vinegars, or sauces.

The foodstuff can be contacted with the pathogenostatic fluid prior to or after subjecting the foodstuff to an HPP technique. Preferably, the contact precedes HPP treatment because this processing order can facilitate packaging and subsequent treatment of the foodstuff. The foodstuff-to-pathogenostatic fluid contacting step can be performed before or after packaging of the foodstuff, simultaneously therewith, after insertion of the foodstuff into a package but prior to sealing of the package, or a combination of these. By way of example, a foodstuff can be soaked in the pathogenostatic fluid prior to packaging, the foodstuff and the fluid can be packaged together, and the contact between the fluid and the foodstuff can continue after packaging. Alternatively, the fluid can be vacuum infused (i.e., at a sub-atmospheric pressure) into the foodstuff, the foodstuff, having the liquid infused therein can be packaged at atmospheric pressure without excess liquid, and the packaged foodstuff can thereafter be subjected to the HPP technique.

Ideally, the foodstuff is contacted with the pathogenostatic fluid under conditions sufficient to achieve a substantially pathogenostatic condition throughout the foodstuff that endures indefinitely. Practically speaking, the sufficiency of the pathogenostatic conditions can be assessed using any method known in the field. By way of example, the pathogenostatic conditions that should be present throughout the foodstuff following the processing described herein can be considered sufficient if vegetative growth of the pathogen is substantially not detectable when the foodstuff is stored in the dark at 4 degrees Celsius for 10 days after having been contacted with the pathogenostatic fluid. Alternatively, this assessment can be made at other temperatures (e.g., at an ambient environmental temperature such as 20 degrees Celsius) and for different periods (e.g., by performing the assessment at 30 days, 3, 6, or 9 months, or at 1, 2, or 3 years). Alternatively, the efficacy of a pathogenostat can be assessed by observing the degree to which vegetative growth of a pathogen is inhibited in an HPP-treated foodstuff, relative to the same HPP-treated foodstuff lacking the pathogenostat. Preferably, the pathogenostat is present at a level that inhibits vegetative growth of a pathogen from pressure-resistant forms by at least a factor of 100,000 (known in the art as a “five log reduction”) relative to an identically-treated sample lacking the pathogenostat. By way of example, a foodstuff treated as described herein can be assessed for one or more of organoleptic qualities, the presence of toxic microbiological products, and the presence of vegetative microorganisms after storage in the dark at 4 degrees Celsius for 10, 30, or 180 days or after storage in the dark at about 20 degrees Celsius for 10 days. Alternatively, the presence, absence, or concentration of expected microbial metabolites (e.g., lactate, other acids, altered pH, specific gases such as hydrogen, or the presence of gases generally) can be used as indicators of germination of pressure-resistant pathogen forms and vegetative growth of the corresponding pathogen in a treated foodstuff

As a skilled artisan in this field understands, the precise assessment used and corresponding acceptable degree of pathogenostatic effectiveness can be selected based on the identity of the foodstuff, the identity of pressure-resistant pathogens known or expected to be present in the foodstuff, the expected conditions and duration of storage, and other characteristics within the ken of a skilled artisan in this field. By way of example, if it can be anticipated that storage and handling of a packaged foodstuff will likely vary from ideal storage conditions (e.g., military or emergency relief rations for which refrigeration may not be consistently available), then the assessments used should take into account the conditions to which the packaged foodstuff may be exposed.

Packaging

The foodstuff can be packaged (or the package sealed) after the HPP technique is performed upon the foodstuff, but is preferably packaged before the HPP technique is performed, because this eliminates the risk that the HPP-treated foodstuff could become contaminated with vegetative microorganisms after HPP treatment, and either before or during packaging.

In a preferred embodiment, a foodstuff is contacted with the pathogenostatic fluid prior to or during packaging, and the foodstuff is packaged into an HPP-compatible package. A wide variety of HPP-compatible packages are known, such as a flexible plastic pouch and a relatively rigid plastic tray having a concave portion and having a flexible plastic lidding material (e.g., a thin transparent sheet) adhered to or fused with the perimeter of the tray about the concavity and conforming to the shape of a foodstuff or collection of foodstuffs contained within the concavity of the tray. The package can contain the foodstuff having the pathogenostatic fluid infused therein (i.e., with no fluid remaining outside the foodstuff), the foodstuff and the pathogenostatic fluid, the foodstuff and a liquid other than the pathogenostatic fluid (e.g., a comestible sauce or liquid intended to aid in cooking the foodstuff), or some combination of these

Substantially any HPP-compatible packaging materials can be used, such as plastic films. Such films include polyethylenes and other polyalkenes, nylons, polyethylene terephthalates, and laminated polymer films known in the food industry. Packaging films having selective permeability characteristics can be used, and a wide variety of such films are known, including those (e.g., ethyl vinyl alcohol copolymers) that exhibit selective permeability to certain gases such as oxygen and water vapor. The package must have sufficient flexibility and resilience at at least one portion thereof that the pressure exerted upon the exterior of the package during HPP treatment can be transmitted into the interior of the package without rupturing the package. Thus, most packages will not contain substantial amounts of gaseous components (which are high compressible and result in high stresses upon the packaging during HPP treatment, leading to an increased likelihood of rupture). However, so long as the materials and structure of the package can maintain their integrity (e.g., not rupture or lose their gas-barrier properties) when subjected to HPP treatment, it is not critical how much headspace is contained within the package. In a commercial package filling line, it can be difficult to fill all or most packages completely, and packages will typically exhibit at least some minimal headspace, even on a vacuum packaging line. Based on experience, headspace (i.e., gas-filled space) of up to at least 5%-8% by volume can occur in typical flexible plastic food packaging without rendering them unsuitable for HPP treatment, by way of example.

Cooking by microwave irradiation of foodstuffs is well known and is a convenient method for rapidly heating foods—especially those containing water or other materials that absorb microwaves produced by consumer microwave ovens. Particularly convenient to consumers are packaged foodstuffs (e.g., sauced vegetables or blends of vegetables with rice or other grains) that can be cooked within their package. Many microwavable packaged foodstuffs are available, for example, in which a foodstuff is contained within a tray having a film sealing a concavity within the tray, there being a substantial headspace between the film and some or all of the foodstuff. Typically, the film must be breached prior to cooking to prevent unexpected or undesirable rupture (e.g., explosion) of the package, and significant gas-filled headspace is typically included between the foodstuff and the film to facilitate such pre-heating breaching. This headspace generally renders them unsuitable for HPP treatment. However, packages having less or no headspace can be difficult to controllably breach prior to microwaving.

A variety of microwavable food packages having mechanical venting systems are known, such as those described in U.S. patent application publications numbers 2011/0179754 and 2005/0276885, and vented packaging is commercially available, such as from Amcor Limited and its subsidiaries Amcor Flexibles Europe & Americas and Amcor Flexibles Asia Pacific. Their use to contain foodstuffs during HPP treatment and thereafter for microwave cooking does not appear to have been previously reported.

The methods disclosed herein can be used to prepare a microwaveable packaged food product. In such methods, it is important to select packaging material such that the filled, sealed package is capable of withstanding HPP treatment while retaining the venting mechanism in an operable state. Two examples of suitable venting systems are the Amcor VENTVALVE brand system and the Amcor PROTECTVALVE brand system, each available from Amcor Limited or one or more of its subsidiaries. Such technologies employ packaging films having weakened sections at identified positions, such that significantly greater pressure within the sealed package (e.g., upon production of steam on microwaving) induces the weakened section(s) to rupture, releasing the pressure in a controlled fashion and at a defined location. Such packages are generally suitable for HPP treatment, which applies pressure equally about and within the package, and especially if the package contains no substantial amount of a compressible fluid such as air or other gases.

Alternatively, if it is not possible to retain the venting function when the sealed package is subjected to HPP treatment, the packaging material and foodstuff can be subjected to the HPP treatment prior to sealing the package, so that the venting functionality of the packaging is retained. Because it can be inconvenient or difficult to complete packaging in a sterile fashion after HPP treatment, the methods preferably involve use of sealed, vented packaging material.

In one embodiment, a foodstuff such as a vegetable, grain, and sauce medley (including the pathogenostatic fluid as described herein) is packaged in a material consisting of a lidding film and a tray that is substantially more rigid than the lidding film. The tray includes a concave portion that contains the foodstuff. The lidding film is sealed about the perimeter of the concave portion (e.g., at the edge of the concavity or beyond that edge, such as at a flat portion that extends away from the edge of the concavity). Within the perimeter seal, the lidding film conforms to (i.e., is closely spaced against) the foodstuff, where present, and the surface of the tray where the foodstuff is not present. A rupturable valve, such as an ultrasonic seal between the lidding film and the tray as described in U.S. patent application publication number 2011/0179754, is also present in the lidding film within the perimeter. Preferably, there is substantially no compressible fluid present between the lidding film and the tray within the perimeter seal. The package can be subjected to an HPP treatment (e.g., maintaining the package within a fluid medium pressurized to 20-87 kpsi for 1 to 10 minutes) without affecting the rupturability of the seal. Such HPP treatment inhibits vegetative microorganisms within the package, and the pathogenostatic fluid within the package inhibits pressure-resistant pathogens that may be present therein. The HPP-treated package exhibits favorable storage characteristics (i.e., including substantially enhanced microbiological safety, relative to the non-treated foodstuff) and can be provided directly to consumers (i.e., as is or included within a package such as a paperboard box). Furthermore, the treated package can be heated by a user in a microwave oven. As the microwave-treated package heats, water vapor or other gases developed upon heating can pressurize the package and cause the seal to rupture. Following microwave treatment, the heated foodstuff can be eaten or served by removing it from the package, such as through the ruptured seal. In one embodiment, the materials and methods used to form the perimeter seal are selected to yield a peelable seal, such that the lidding film (including the now-ruptured seal) can be removed substantially intact from the tray, and the heated foodstuff can be served in the tray.

For packages which include a pressure-rupturable seal and that will be subjected to HPP treatment in a sealed configuration, it is important that the materials, construction, package contents, and HPP treatment be selected such that HPP-treatment of the sealed package will not induce rupture of the seal. For example, packages which contain substantial amounts of a compressible fluid (e.g., air or a modified atmosphere) can deform upon the compression that occurs during HPP treatment, and such deformation can rupture or significantly weaken rupturable seals. A skilled artisan is able to determine (e.g., empirically) appropriate amounts of compressible fluid that can be retained within a sealed package for any combination of materials, construction, package contents, and HPP treatment.

In one embodiment, the package that is subjected to HPP treatment is either the same package that will be presented to consumers of the foodstuff (i.e., the retail package, having desired labels or printing thereon) or a package that can be conveniently mated with a retail package (e.g., a plastic pouch having a defined size and shape selected to mate with a cardboard or paper sleeve or label).

Vacuum packaging (including partial vacuum packaging, such as is performed to remove only most gas or vapor from a package prior to sealing) is a preferred packaging method, because application of a lowered pressure to a foodstuff and subsequent increase in the pressure when the foodstuff contacts the pathogenostatic fluid can induce infusion of the fluid into the foodstuff. Furthermore, many vacuum packaging techniques can readily incorporate HPP-compatible materials. Thus, a pathogenostatic fluid-contacted foodstuff packaged in an package can be readily made and is highly compatible with the HPP treatment that is part of the methods that are disclosed herein. In a preferred embodiment, the foodstuff is packaged (either together with excess pathogenostatic fluid or having it infused within the foodstuff) in a flexible plastic pouch formed by fusion, lamination, or other assembly of two or more plastic sheets (or a single sheet, folded back upon itself) along a seam, the laminated sheets being separable along at least a part of the seam by peeling (i.e., the sheets can be peeled, and the container opened, using ordinary human strength). Alternatively, the laminated sheets can be fused, such that the interior of the package cannot practically be accessed other than by breaching at least one of the sheets.

HPP Treatment

In addition to being contacted with the pathogenostatic fluid, the foodstuff is also subjected to an HPP treatment. The precise nature of the HPP treatment employed is not critical. Substantially any HPP method known to inhibit vegetative microorganisms can be used. Preferably, an HPP method is selected that is known to be effective against the particular microorganisms (particularly any pathogenic microorganisms) known or believed to occur in the foodstuff being processed. HPP methods are well known and described in the art.

HPP equipment typically uses a working fluid, most commonly water. Such equipment typically includes a pressure chamber into which a foodstuff is placed. After loading (i.e., placement of the foodstuff within the pressure vessel), the chamber is filled with the working fluid, and the chamber is pressurized by application of a high hydrostatic pressure (e.g., 20-120 kpsi, more typically 35-87 kpsi) to the working fluid. Such pressurization of liquids and liquid-containing foodstuffs ordinarily results in adiabatic heating that is substantially reversed upon de-pressurization. It is known that such heating can be modulated (e.g., by controlling the temperature of the working fluid, such as by cooling it), and that such modulation can be beneficial for heat-sensitive foodstuffs. Such temperature modulation can be practiced in HPP techniques employed in the methods described herein.

Because pressure within a fluid in a chamber is uniform throughout the fluid, and because the working fluid in an operating HPP apparatus completely surrounds the foodstuff, the hydrostatic pressure within the chamber is applied isotropically (i.e., not in any particular direction more than another) to the foodstuff. So long as the foodstuff does not contain excessive compressible materials (e.g., gases such as air bubbles within the foodstuff and in headspace above the foodstuff; water and other fluids tend to be substantially incompressible at HPP pressures), the shape of the foodstuff tends not to be altered significantly (even though some microscopic changes may occur, such as denaturation of proteins within the foodstuff). Furthermore, foodstuffs that do not include portions capable of withstanding deformation at the applied pressure will also transmit the pressure within the foodstuff, the result being that the hydrostatic pressure applied to the chamber occurs throughout the treated foodstuff.

Maintenance of the foodstuff at the applied pressure results in damage to microorganisms (e.g., bacteria, molds, yeast, and parasites) that may be present on or within the foodstuff. Regardless of the precise nature of the damage, microorganisms (other than pressure-resistant forms of microorganisms, such as bacterial spores and protozoan cysts) subjected to HPP treatment appear to replicate and metabolize at substantially lower rates than non-HPP-treated microorganisms. This effect is the primary basis for the desirability of HPP treatment of foodstuffs.

The HPP technique should ideally be selected to be sufficient to render all microorganisms non-vegetative throughout the foodstuff after the foodstuff is subjected to the HPP technique. More practically, the technique should be selected such that no more than a small, selected number of microorganisms (or, at least, pathogenic microorganisms) reasonably anticipated to be present in the foodstuff to be processed are rendered non-vegetative by the treatment. The expected effectiveness of an HPP treatment method will also depend on the identity and form of the foodstuff, the identity and nature of microorganisms that can reasonably be anticipated to be present in the foodstuff, the nature of any packaging containing the foodstuff, the temperature of the foodstuff, and other factors within the ken of a skilled artisan in this field. Methods of assessing and enumerating vegetative microorganisms and appropriately safe and desirable levels of such organisms are known to or determinable by a skilled artisan in the field of food microbiology.

By way of example, it can be desirable to select an HPP processing technique that yields a foodstuff in which substantially no vegetative growth of the microorganisms can be detected when the foodstuff is stored in the dark at 4 degrees Celsius for 10 days after having been subjected to the HPP technique. Alternatively, this assessment can be made at other temperatures (e.g., at an ambient environmental temperature such as 20 degrees Celsius) and for different periods (e.g., by performing the assessment at 30 days, 3, 6, or 9 months, or at 1, 2, or 3 years). Alternatively, the HPP technique and parameters can be selected to effect a five log reduction in the treated sample (i.e., the load of viable microorganisms in the sample is reduced by a factor of 100,000 or more by the HPP treatment). As a skilled artisan in this field understands, the precise assessment used and corresponding acceptable degree of pathogenostatic effectiveness can be selected based on the identity of the foodstuff, the identity of microorganisms known or expected to be present in the foodstuff, the expected conditions and duration of storage, and other characteristics within the ken of a skilled artisan in this field.

The Foodstuff

The method disclosed herein are useful for processing a wide variety of foodstuffs. Liquid foodstuffs (e.g., fruit and vegetable juices, soups, stocks, dressings, sauces, and frozen dessert precursors) and liquid-containing foodstuffs (e.g., fruits, vegetables, meats, pastes, pastas, and cheeses), for example, are highly suitable for processing as described herein. Foodstuffs having gaseous inclusions (e.g., breads, mousses, and crackers) are generally unsuitable for the processes described herein (or for any HPP method, for that matter on accounting of the compressing effects of such treatments), although ingredients (e.g., flours, sugars, and non-yeast-containing doughs) for making such foodstuffs can be processed herein.

The techniques described herein can be particularly attractive for processing fruits and vegetables in ways that significantly extend their shelf life without significantly degrading the organoleptic properties associated with fresh fruits and vegetables. Others have described HPP processing of fruits and vegetables. However, owing to the ineffectiveness of HPP techniques for inhibiting or inactivating pressure-resistant forms of pathogens, elimination of pressure-resistant pathogens from fruits and vegetables HPP-treated as described by others required additional processing that was either costly and required substantial effort (e.g., freezing or refrigeration) or significantly altered the organoleptic properties associated with fresh fruits and vegetables (e.g., heating or other cooking prior to storage).

It is known that HPP treatment can alter the organoleptic properties of various foodstuffs. Preferably, the HPP treatment(s) used in the methods described herein are selected so that they yield a foodstuff which, after such treatment(s) retains favorable organoleptic properties.

It is well known that the effective storage life of many foodstuffs (i.e., the period of time a foodstuff may be maintained at a storage condition while retaining comestibility or utility as a comestible ingredient) can be extended by refrigeration. In addition to slowing the rate of abiotic chemical reactions that can lead to incomestibility, refrigeration also reduces the rates of microbial growth and proliferation and of conversion of spores and cysts to vegetative forms. Because microorganisms generally proliferate by division, their growth-in-number proceeds logarithmically, rather than linearly, in proportion to their initial numbers. Because HPP and pathogenostat treatment as described herein can dramatically decrease the number of viable vegetative microorganisms and the rate of germination of pressure-resistant microbiological forms (e.g., spores and cysts), such treatment coupled with refrigeration can dramatically extend the effective storage life of foodstuffs.

Particularly for foodstuffs (e.g., many fruits and vegetables) which retain a high level of comestibility when refrigerated in the absence of microbial contamination, the treatment methods described herein can be used to dramatically extend the period for which such treated foodstuffs can be maintained in a comestible state under refrigeration, such as for 10, 30, 60, 180, or 360 days, or even 2 or 3 years.

The techniques described herein are also beneficial in that they facilitate packaging of foodstuffs such as vegetables and fruits together with a sauce or other liquid, with the amount of sauce packaged with the foodstuff being readily controllable. For example, the techniques can be used to package cut green beans, pearl onions, and rice having a flavor included in the pathogenostatic liquid infused into the beans, onions, and rice (or different flavored pathogenostatic liquids infused into each) but no free liquid upon opening the package. Similarly, the techniques can be used to package cut cauliflower florets having a pathogenostatic liquid infused therein and also having a comestible sauce packaged therewith (with the level of pathogenostat infused into the florets being selected to account for expected diffusion into the co-packaged sauce over time with storage, such as a sufficient amount of an acidifying agent to impart a final pH not greater than about 4.6 throughout the florets and the sauce) such that a ready-to-eat sauced cauliflower dish can be prepared merely by contacting the package with boiling water (or heating it in a microwave oven) for several minutes prior to peeling or cutting open the package and pouring its contents onto a serving dish or dinner plate. Each of these packaged products can be stored, with or (in some instances) without refrigeration, for days, weeks, months, or years.

The disclosure of every patent, patent application, and publication cited herein is hereby incorporated herein by reference in its entirety.

While this subject matter has been disclosed with reference to specific embodiments, it is apparent that other embodiments and variations can be devised by others skilled in the art without departing from the true spirit and scope of the subject matter described herein. The appended claims include all such embodiments and equivalent variations.

What is claimed is:

1. A method of enhancing the microbiological safety of a foodstuff that potentially harbors a pressure-resistant pathogen and vegetative microorganisms, the method comprising:
contacting the foodstuff with a pathogenostatic fluid under conditions sufficient to inhibit the pressure-resistant pathogen throughout the foodstuff and
subjecting the foodstuff to a high pressure processing (HPP) technique sufficient to reduce the fraction of the microorganisms that are vegetative.

2. The method of claim 1, wherein the foodstuff is contacted with the fluid prior to subjecting the foodstuff to the HPP technique.

3. The method of claim 1, wherein the fluid is a liquid and the foodstuff is substantially immersed in the liquid and subjected to depressurization and repressurization prior to subjecting the foodstuff to the HPP technique.

4. The method of claim 1, wherein the foodstuff is contacted with the fluid under conditions sufficient to achieve a substantially pathogenostatic condition throughout the foodstuff

5. The method of claim 4, wherein vegetative growth of the pathogen is substantially not detectable when the foodstuff is stored in the dark at 4 degrees Celsius for 10 days after having been contacted with the fluid.

6. The method of claim 4, wherein vegetative growth of the pathogen is reduced by a factor of at least 100,000 relative to an otherwise identical foodstuff not contacted with the pathogenostatic fluid.

7. The method of claim 1, wherein the foodstuff is sealed within an HPP-compatible package after contacting the foodstuff with the fluid and before subjecting the foodstuff to the HPP technique.

8. The method of claim 7, wherein the fluid is a liquid and the foodstuff is substantially immersed in the liquid and subjected to depressurization prior to sealing the package.

9. The method of claim 7, wherein the sealed package contains the foodstuff and at least some of the liquid is not infused within the foodstuff.

10. The method of claim 7, wherein the sealed package contains the foodstuff and substantially none of the liquid other than the liquid that is infused within the foodstuff.

11. The method of claim 7, wherein a comestible sauce is sealed within the package.

12. The method of claim 7, wherein the package comprises a plastic film interposed between the foodstuff and the exterior of the package.

13. The method of claim 12, wherein the film is substantially impermeable to oxygen.

14. The method of claim 12, wherein the film is substantially transparent.

15. The method of claim 12, wherein the package comprises a flexible plastic film laminated against a more rigid plastic tray having a concavity, the foodstuff being disposed within the concavity and the film being laminated against the tray about the periphery of the concavity.

16. The method of claim 15, wherein the film is peelably laminated against the tray.

17. The method of claim 15, wherein the package has a vent communicating with each of the exterior of the package and the space between the film and the tray within the concavity, the vent being capable of opening when the pressure within the package substantially exceeds the pressure of the environment surrounding the package by an amount less than the bursting strength of the package.

18. The method of claim 15, wherein any gas interposed between the film and the tray within the concavity has a volume not greater than about 8% of the total volume of the space between the film and the tray within the concavity.

19. The method of claim 1, wherein the HPP technique is selected to render the microorganisms substantially non-vegetative throughout the foodstuff

20. The method of claim 19, wherein vegetative growth of the microorganisms is substantially not detectable when the foodstuff is stored in the dark at 4 degrees Celsius for 10 days after having been subjected to the HPP technique.

21. The method of claim 19, wherein vegetative growth of the microorganisms is reduced by a factor of at least 100,000 relative to an otherwise identical foodstuff not subjected to the HPP technique.

22. The method of claim 1, wherein the fluid is acidic and the foodstuff is contacted with the fluid under conditions sufficient to reduce the pH to a value not greater than 4.6 throughout the foodstuff.

23. A packaged food article comprising a sealed, HPP-compatible flexible package containing
a foodstuff that is susceptible to contamination with a pressure-resistant form of a pathogen, the foodstuff being selected from foodstuffs having organoleptic properties that are not substantially altered by HPP treatment, but which are substantially altered by heat treatment sufficient to substantially inhibit the pressure-resistant form;
in contact with a pathogenostatic fluid in an amount sufficient to inhibit the pressure-resistant form throughout the foodstuff

24. A microwavable packaged food article, the article comprising
a foodstuff that is susceptible to contamination with a pressure-resistant form of a pathogen and an effective amount of a pathogenostat contained within a sealed package capable of withstanding at least 20 kpsi of isotropically-applied pressure without rupturing,
the package having a vent capable of opening when the pressure within the package substantially exceeds the pressure of the environment surrounding the package by an amount less than the bursting strength of the package,
the foodstuff being heat labile and not having been heated to a temperature sufficiently high to substantially trigger such lability,
wherein vegetative growth of the pathogen in the food article is substantially not detectable when the food article is stored in the dark at 4 degrees Celsius for 10 days.
